(19) United States
(12) Patent Application Publication
(10) Pub. No.: US 2026/0268255 A1
(43) Pub. Date: Sep. 10, 2026

(54) HIERARCHICAL CAUSAL ATTRIBUTION MODEL FOR DETERMINISTIC PERFORMANCE DECOMPOSITION AND MULTI-LEVEL METRIC ATTRIBUTION

(71) Applicant: Todd VanderStelt, Lakewood, CO (US)

(72) Inventor: Todd VanderStelt, Lakewood, CO (US)

(21) Appl. No.: 19/070,768

(22) Filed: Mar. 5, 2025

(51) Int. Cl. G06Q 10/0635; G06Q 10/10

(52) U.S. Cl. CPC G06Q 10/0635; G06Q 10/10

(57) ABSTRACT

Systems and methods for hierarchical causal attribution modeling are provided. An example method include receiving reports related to a business enterprise, based on the reports, determining a first set of values for business metrics for a first period and a second set of values for the business metrics for a second period, the business metrics including absolute metrics and calculated metrics, identifying changes in the business metrics based on a comparison of the first set of values and the second set of values, determining, using a hierarchical decomposition model and a cross-metric attribution model, a set of factors contributing to the changes in the business metrics, determining, based on predictable rules using deterministic functional relationships, rather than probabilistic statistical inference, a set of impacts of the set of factors, and visualizing the set of impacts for a user through interactive dashboards, reports, or automated messaging systems.

### TECHNICAL FIELD

The present disclosure relates generally to data processing and, more particularly, to systems and methods for deterministic hierarchical causal attribution modeling.

### BACKGROUND

Current Business Intelligence (BI) and Machine Learning (ML) models often rely on correlation-based analyses, probabilistic inference methods, and machine learning feature ranking techniques. While these approaches can identify statistical relationships, they fail to establish direct causal mechanisms, particularly when dealing with complex hierarchical relationships or calculated business metrics, that explain why business metrics change over time.

Correlation-based methods, such as regression models and feature importance scores from ML algorithms, capture relationships between variables but do not establish causal directionality or quantify contribution impact with precision.

Probabilistic inference models, including multi-touch attribution (MTA) and marketing mix modeling (MMM), estimate the impact of various factors using statistical likelihoods rather than explicit causal mappings.

Machine learning feature ranking methods, like SHAP (SHapley Additive exPlanations) and LIME (Local Interpretable Model-agnostic Explanations), provide post-hoc estimations of feature importance but lack structured attribution models that break down the relationships between business inputs and metric shifts.

Due to these limitations, current methods struggle to accurately trace performance changes to their root causes, leading to unreliable decision-making and misallocation of resources. Despite their analytical power, these existing approaches have the following notable limitations.

Inaccurate Metric Attribution: Current methods struggle to precisely attribute changes in key business metrics—such as Advertising Cost of Sales (ACOS), Return on Advertising Spend (ROAS), Conversion Rate (ConvR), Cost Per Acquisition (CPA), and Average Order Value (AOV)—to specific business inputs or actions.

Limited Decomposition of Hierarchical Metrics: They fail to break down complex, hierarchical business metrics into clear input-output relationships, making it difficult to understand and optimize business performance.

Black-Box Models with Limited Transparency: Many AI-driven models operate as “black boxes,” offering feature importance scores without clear mathematical mappings that explain how specific inputs influence business outcomes.

Given the importance of accurate performance attribution in driving strategic business decisions, there is a pressing need for BI and ML frameworks that incorporate structured causal reasoning. Such frameworks need to move beyond probabilistic modeling and statistical inference, instead providing structured, deterministic attribution methods that explicitly map input actions to performance outcomes.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Embodiments of the present disclosure relate to causal performance attribution modeling, and specifically to systems and methods for hierarchical causal attribution modeling (HCAM). Some embodiments of the present disclosure provide a structured method for decomposing performance shifts in absolute and calculated business metrics using deterministic, hierarchical, and mathematically structured decomposition, rather than relying on correlation-based or probabilistic statistical inference methods. The HCAM framework employs an attribution structure referred to as the Bridge Cube. The Bridge Cube includes:

The Vertical Bridge, which decomposes a single business metric, whether absolute (e.g., revenue) or calculated (e.g., ACOS), into its hierarchical components, enabling businesses to isolate performance shifts at multiple levels (e.g., ASIN, category, campaign).

The Horizontal Bridge, which quantifies the cross-metric impact of multiple performance drivers, determining how changes in input metrics (e.g., Traffic, Conversion Rate, ASP) contribute to changes in both absolute and calculated performance metrics (e.g., Revenue).

Causal Impact Quantification, which assigns mathematical contributions to both direct and indirect factors affecting business outcomes.

This structured approach allows HCAM to provide deterministic causal explanations rather than statistical correlations, probabilistic estimations, or black-box machine learning models that lack explicit functional mappings.

According to one example embodiment of the present disclosure, a method for HCAM is provided. An example method includes receiving reports related to a business enterprise and, based on the reports, determining a first set of values for business metrics for a first period and a second set of values for the business metrics for a second period. The method includes identifying changes in the business metrics based on a comparison of the first set of values and the second set of values. The method also includes determining, using a hierarchical decomposition model (Vertical Bridge) and a cross-metric attribution model (Horizontal bridge), a set of factors contributing to the changes in the business metrics. The method also includes determining, based on predictable rules using deterministic functional relationships, rather than probabilistic statistical inference, a set of impacts of the set of factors and visualizing the set of impacts for a user.

The set of impacts is visualized as a table, dashboard, or other structured visualization format. Rows of the table correspond to factors of the set of factors. The factors include individual factors and sub-factors contributing to the changes in the business metrics. Columns of the table correspond to the business metrics at multiple levels of aggregation. The business metrics include absolute metrics and calculated metrics. The table, or visual, is dynamically adjusted to reflect real-time performance shifts in the business metrics based on updated data in the reports.

The method may include determining a primary factor of the set of factors. The primary factor results in one of the following: the largest direct impact on a change in a business metric of the business metrics and a largest indirect impact on the change in the business metric. The method includes generating a message concerning the primary factor and the change in the business metric corresponding to the primary factor and displaying the message to the user. In some embodiments, the message may be generated by a pretrained neural network, such as a large language model (LLM), optionally enhanced using Retrieval-Augmented Generation (RAG) to retrieve structured attribution data before generating explanations.

Factors in the set of factors are arranged in a hierarchical tree. The hierarchical tree includes a vertical bridge decomposition layer and a horizontal bridge attribution layer. The vertical bridge decomposition layer includes at least one parent node corresponding to a primary business metric of the business metrics and at least one child node associated with the at least one parent node. The child node corresponds to a contributing dimension contributing to the primary business metric. The vertical bridge decomposition layer includes at least one sub-level node associated with the child node. The sub-level node corresponds to an individual entity identifier associated with the contributing dimension. The horizontal bridge attribution layer includes at least one further parent node corresponding to a calculated business metric of the business metrics and at least one further child node associated with the further parent node. The further child node corresponds to an input driver contributing to the calculated business metric.

The method includes applying a decomposition for an absolute business metric of the business metrics to determine first components and second components. The first components correspond to contributions of shifts in underlying data dimensions to a total change of the absolute business metric. The second components isolate the total change of the absolute business metric from the first components. The method includes applying an attribution for a calculated business metric of the business metrics to quantify a contribution of an input driver to the calculated business metric. Method includes determining a first shift in the calculated business metric and a second shift in the calculated business metric. The first shift is caused by budget allocation changes (mix shift) and the second shift being caused by a rate driven change.

Method includes providing an application programming interface (API). The API configured to receive an attribution query concerning the set of impacts and return attribution data based on the set of impacts in real time. The API can process attribution queries in both synchronous and asynchronous modes. The API can continuously receive the reports as a batch of first streaming data and continuously return second streaming data including the set of impacts based on the reports. The API can generate an alert message based on predetermined thresholds on the business metrics.

Method includes generating a message concerning attribution data including impacts of the set of impacts to the changes to the business metrics and a summary concerning the changes in the business metrics and displaying the message to the user. The attribution data are retrieved and structured using a retrieval-augmented generation (RAG) system, which ensures that AI-generated insights align with deterministic attribution outputs. The summary is generated by a large language model (LLM). The message is presented in a natural language and preserves the attribution data.

The set of factors includes a factor associated with one or more of the following: an advertisement campaign, a brand associated with a product, a category of the product, and a geographical location. The set of factors includes an external factor associated with one or more of the following: a media event associated with a third party, a weather event, and a shift in search-related traffic associated with at least one search platform. External factors are integrated as contextual overlays rather than direct causal attributions to maintain deterministic attribution integrity.

The business metrics include a business metric associated with one or more of the following: a category of products, a brand associated with the products, and a price tier of the products.

The business metrics include input metrics and at least one performance metric calculated based on the input metrics. The input metrics include one or more of the following: a number of times a product displayed on a web page displayed to users, a number of clicks on the web page, a number of sales of the product, cost of an order of the product, and an advertisement spend. The performance metric includes one or more of the following: an advertisement cost of sales, cost per click, an advertisement conversion rate, and an average order value. Performance metrics may be derived using deterministic functional relationships that explicitly map input metrics to calculated business outcomes.

According to another embodiment, a system for HCAM is provided. The system may include at least one processor and a memory storing processor-executable codes, wherein the processor can be configured to implement the operations of the above-mentioned method for HCAM.

According to yet another aspect of the disclosure, there is provided a non-transitory processor-readable medium, which stores processor-readable instructions. When the processor-readable instructions are executed by a processor, they cause the processor to implement the above-mentioned method for HCAM. The processor-readable medium may be deployed in on-premise, cloud-based, or distributed computing environments to facilitate large-scale attribution modeling.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example environment, in which system and methods for HCAM can be implemented, according to some example embodiments.

FIG. 2 is a block diagram showing HCAM system, according to some example embodiments.

FIG. 3 is a schematic diagram showing data used by HCAM system, according to some example embodiments.

FIG. 4 is a schematic diagram showing example dashboard screens, according to an example embodiment.

FIG. 5 depicts an example dashboard screen, according to an example embodiment.

FIG. 6 is a schematic diagram depicting example messages generated by HCAM system, according to some example embodiments.

FIG. 7 is a flow diagram showing a method for HCAM, according to some example embodiments.

FIG. 8 is a high-level block diagram illustrating an example computer system, within which a set of instructions for causing the machine to perform any one or more of the methodologies discussed herein can be executed.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and operational changes can be made without departing from the scope of what is claimed. The following detailed description is, therefore, not to be taken in a limiting sense, and the scope is defined by the appended claims and their equivalents.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.” The terms “can” and “may” shall mean “possibly be, but not limited to be.”

This disclosure describes methods and systems for HCAM that enable deterministic decomposition of performance metrics and multi-level attribution within a structured business intelligence framework. HCAM does not rely on inferred statistical relationships but instead applies explicit functional mappings to quantify metric shifts. Specifically, HCAM introduces a Bridge Cube framework, which integrates two complementary attribution methodologies:

The Vertical Bridge, which hierarchically decomposes a single business metric (e.g., Revenue) across multiple dimensions (e.g., Brand, Product, SKU) using deterministic functional equations to identify contributing factors at different organizational levels.

The Horizontal Bridge, which quantifies how multiple input metrics interact through explicit functional dependencies to drive changes in key performance outcomes, ensuring that metric shifts are not analyzed in isolation but as part of an interconnected system.

Unlike correlation-based BI and ML models, which infer relationships through statistical estimations, HCAM explicitly calculates deterministic causal relationships using structured functional decomposition. By modeling causal dependencies explicitly rather than probabilistically estimating them, HCAM ensures that performance attribution remains mathematically verifiable. The system is designed for real-time integration into SaaS and Business Intelligence (BI) platforms, ensuring precise, actionable insights.

According to one embodiment of the present disclosure, a method for HCAM is provided. The method includes receiving business performance data, identifying and quantifying performance changes, applying vertical bridge analysis for single-metric decomposition, applying horizontal bridge analysis for cross-metric attribution, and generating attribution reports with visualizations. The method begins with receiving business performance reports containing both absolute and calculated metrics for two distinct time periods. These reports serve as the input data for subsequent analysis ensuring that attribution is derived from explicit functional mappings rather than inferred statistical relationships.

Next, the method identifies and quantifies performance changes by determining the first set of values for business metrics corresponding to a first time period and a second set of values for a second time period. The method then calculates absolute and percentage-based changes in performance across all monitored metrics to establish a comparative basis for attribution analysis. These calculations form the foundation for applying deterministic functional mappings that explicitly link observed shifts to underlying business drivers

The method further includes applying Vertical Bridge Analysis (single-metric decomposition) to decompose shifts in performance metrics hierarchically, quantifying the contributions from underlying business dimensions. For example, if revenue increases by 15%, the model determines the respective contributions of each Stock Keeping Unit (SKU), brand, and region to this increase, thereby enabling a structured breakdown of business performance shifts.

Additionally, the method applies Horizontal Bridge Analysis (Cross-Metric Attribution) to quantify how changes in multiple input metrics interact to influence overall performance outcomes. This quantification is based on explicit functional dependencies that define how input variables contribute to output changes through deterministic relationships. For example, if revenue increases by 15%, the model calculates the proportion of this increase attributable to variations in traffic (+10%), conversion rate (+3%), and average selling price (ASP) (+2%), thereby establishing clear causal relationships between input metrics and output performance.

Finally, the method includes generating attribution reports and visualizations. The results are displayed in structured attribution tables, dashboards, and AI-assisted reports, allowing users to trace each performance shift to its root cause with explicit, deterministic calculations. AI-generated reports may be enhanced using Retrieval-Augmented Generation (RAG), ensuring that system-generated insights remain grounded in structured attribution data rather than inferred statistical summaries. These reports enhance business intelligence by providing precise insights into the drivers of performance fluctuations, facilitating data-driven decision-making.

According to another embodiment, the HCAM system includes the following components:
Metric Decomposition Engine: Extracts business metric shifts and applies deterministic decomposition rather than statistical inference.
Hierarchical Attribution Layer:
   Single-Metric Decomposition Module (Vertical Bridge): Constructs a hierarchical structure to quantify contributions at each organizational level.
   Cross-Metric Attribution Module (Horizontal Bridge): Analyzes how multiple performance drivers interact to influence a target metric.
Causal Impact Quantification Module: Assigns mathematical weightings to each contributing factor, differentiating between direct and indirect causal effects.
Real-Time Data Processing & API Integration: Enables HCAM insights to be embedded in BI dashboards, enterprise analytics stacks, and SaaS decision intelligence platforms.

Unlike conventional attribution models, which face challenges in analyzing calculated performance metrics due to their interdependencies and non-linear transformations, HCAM system introduces a structured, deterministic framework for handling both absolute and calculated metrics across multiple hierarchical levels.

In one embodiment, H-CAM applies a Vertical Bridge (Rate/Mix Decomposition) methodology to ensure that shifts in calculated metrics are accurately decomposed across hierarchical levels. This approach accounts for scenarios where denominator values may be zero, preventing mathematical errors such as infinite or undefined results. For example, in the case of Advertising Cost of Sales (ACOS), which is traditionally defined as: ACOS=Ad Spend÷Ad Sales. If Ad Spend is greater than zero but Ad Sales equals zero, conventional models return an undefined or infinite value. HCAM system restructures the decomposition equation to account for these edge cases, ensuring mathematically sound attribution. This same framework is applied to other calculated metrics such as Return on Advertising Spend (ROAS), Conversion Rate (ConvR), Cost per Click (CPC), and Cost per Acquisition (CPA).

In addition, HCAM system implements a Horizontal Bridge (Cross-Metric Attribution for Both Absolute & Calculated Metrics) to map both absolute and calculated output metrics to their direct, controllable input drivers. For calculated metrics, HCAM system explicitly quantifies the influence of each input driver. For example, in the case of ACOS defined as ACOS=(CPC÷ConvR)÷Average Order Value (AOV), HCAM system determines the precise impact of CPC, ConvR, and AOV on changes in ACOS. Similarly, for absolute metrics, HCAM system provides granular attribution. For example, in the case of advertising sales Ad Sales=Clicks×ConvR×AOV, HCAM attributes changes in Ad Sales to the precise contributions of traffic (clicks), conversion rate, and AOV.

By employing this structured, deterministic approach, the HCAM system ensures that every change in a performance metric—whether absolute or calculated—is fully mapped to its controllable input factors. This enables precise attribution, enhances analytical transparency, and supports real-time data-driven decision-making.

Unlike conventional solutions, which treat business metrics as independent variables or apply feature importance ranking methods, often relying on heuristic weighting or machine-learned feature importance scores, the HCAM system introduces a structured Bridge Cube framework that integrates both Vertical Bridge (single-metric decomposition) and Horizontal Bridge (cross-metric attribution). This integration ensures that every metric attribution is derived through direct, functional relationships rather than statistical approximations.

Vertical Bridge: Enables precise attribution within a tree-based structure, ensuring that each business metric (e.g., Revenue) is broken down into granular contributing dimensions (e.g., Region→Brand→SKU).

Horizontal Bridge: Ensures cross-metric attribution by mapping how multiple performance drivers (Traffic, Conversion Rate, ASP) collectively impact a target metric.

This tree-based structure allows HCAM to explicitly calculate contributions at every level of the business metric hierarchy, eliminating the need for inferred relationships or probabilistic estimations.

Unlike heuristic or probabilistic AI models that infer causality based on statistical correlations, HCAM provides true cause-and-effect mapping using structured mathematical relationships. Existing AI and BI Models:
Use feature importance techniques (e.g., SHAP, LIME) that identify correlations but lack a structured decomposition model.
Struggle to attribute calculated performance metrics (e.g., ACOS, ROAS, ConvR) due to their interdependent nature.
Require large historical datasets to infer relationships, leading to lagging insights rather than real-time actionability.

In contrast to Existing AI and BI Models, HCAM's Structured Attribution:
Explicitly maps input changes to output variations using deterministic equations.
Handles both absolute and calculated metrics by structuring decomposition into Rate/Mix attribution for single metrics (Vertical Bridge) and multi-metric interactions (Horizontal Bridge).
Operates in real time, allowing businesses to diagnose performance shifts without relying on historical model training or probabilistic estimations.

Additionally, in contrast to models that depend on historical data, the HCAM system operates in real time, facilitating immediate course corrections in decision-making. Unlike Marketing Mix Modeling (MMM), Multi-Touch Attribution (MTA), or Machine Learning (ML) feature models—which require large historical datasets—HCAM system provides immediate, real-time analysis. MMM and MTA models, in particular, rely on historical correlations to infer relationships, making them less effective in responding to dynamic business conditions in real time.

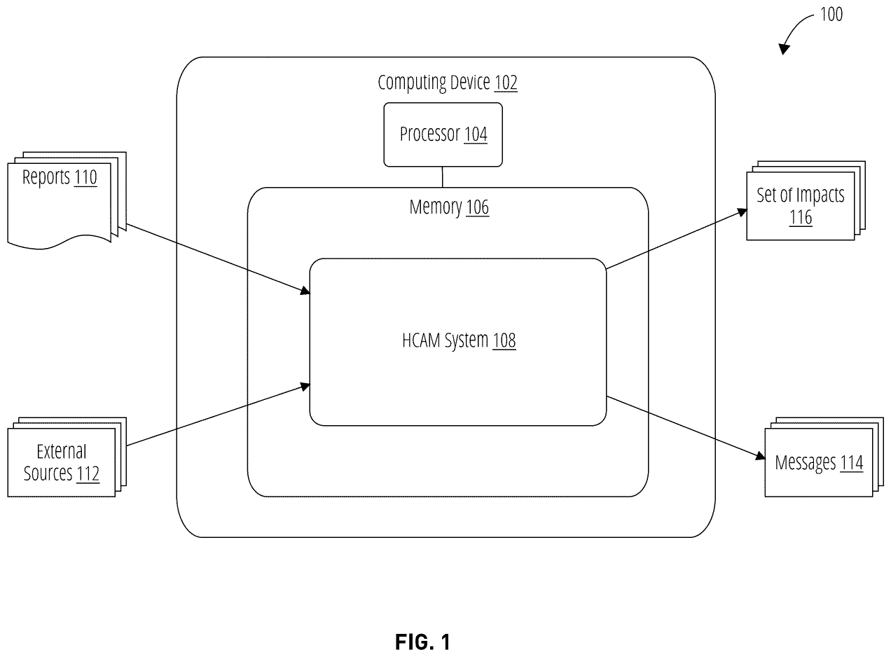

Referring now to the drawings, FIG. 1 shows an example environment 100, in which systems and methods for HCAM can be implemented. Environment 100 may include a computing device 102 including a processor 104 and a memory 106. Memory 106 may store, as processor-executable instructions, an HCAM system 108.

Computing device 102 may include, but is not limited to, a notebook computer or desktop computer. In some embodiments, computing device 102 can be a part of cloud-based computing resource(s) shared by multiple users. The cloud-based computing resource(s) can include hardware and software available at a remote location and accessible over a data network. The cloud-based computing resource(s) can be dynamically re-allocated based on demand. The cloud-based computing resource(s) may include one or more server farms/clusters including a collection of computer servers that can be co-located with network switches and/or routers.

Generally, in various embodiments, HCAM system 108 can be deployed across a flexible computing architecture that supports both on-premise and cloud-based processing. The computing infrastructure consists of:

Local Computing Resources (Edge Processing):
HCAM may be implemented on notebook/desktop computers for localized processing of business intelligence insights.
Suitable for smaller-scale applications where real-time API access is unnecessary.

Cloud-Based Computing Resources (Distributed Processing):
As shown in FIG. 1, HCAM's cloud-based architecture dynamically allocates computing resources, ensuring real-time attribution at scale.
Enables on-demand processing of both Vertical Bridge (single-metric decomposition) and Horizontal Bridge (cross-metric attribution).
Facilitates seamless integration with SaaS and BI platforms via API-based service layers.

By leveraging cloud scalability and distributed processing, HCAM ensures that structured attribution insights are generated in real time, without latency, regardless of dataset size or complexity.

In some embodiments, HCAM system 108 processes business performance reports and structures data for deterministic causal attribution across multiple analytical layers. HCAM system 108 may ingest raw business metrics, decompose them using Vertical Bridge and Horizontal Bridge, and outputs structured attribution insights in dashboard visualizations and structured reports.

The data processing pipeline of the HCAM system is designed to efficiently handle and analyze raw business performance data for attribution modeling. Initially, the system ingests various raw business metrics, such as Ad Spend, Revenue, Clicks, and Conversion Rate, and organizes this data into a structured format suitable for subsequent analysis.

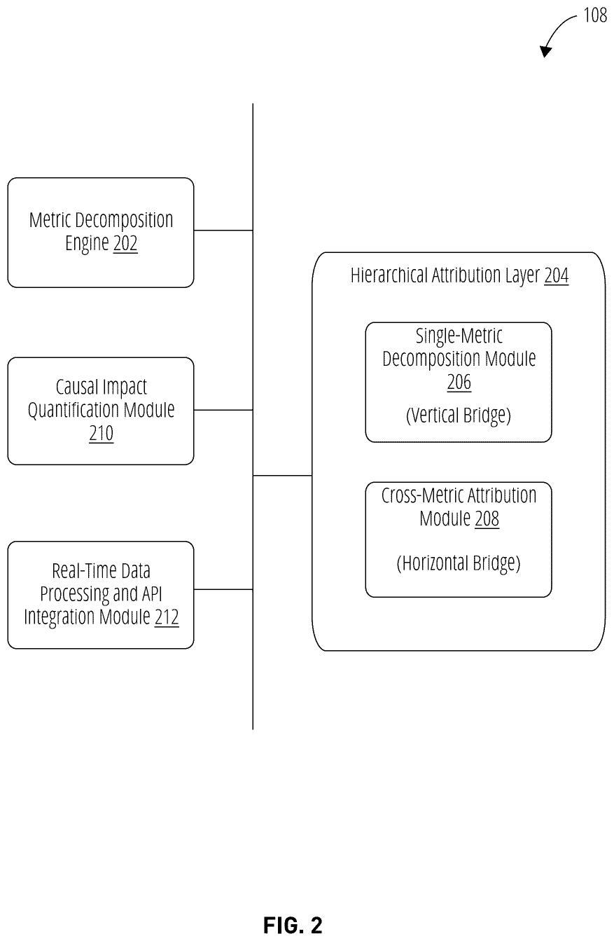

A key component, the Metric Decomposition Engine (shown in FIG. 2), employs deterministic logic to divide the incoming data into absolute and calculated metrics. This ensures a well-organized and methodical approach to processing the data for accurate attribution.

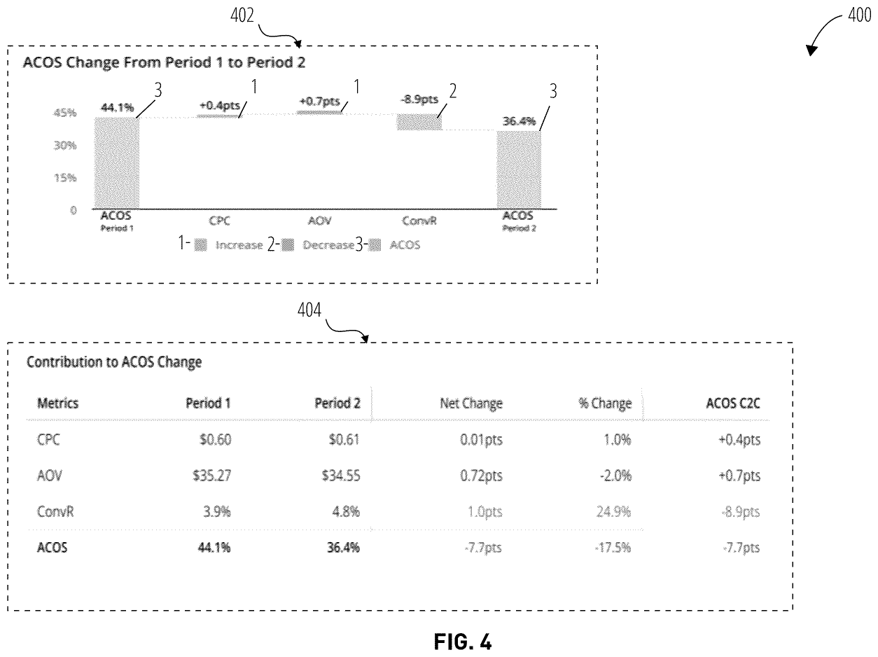

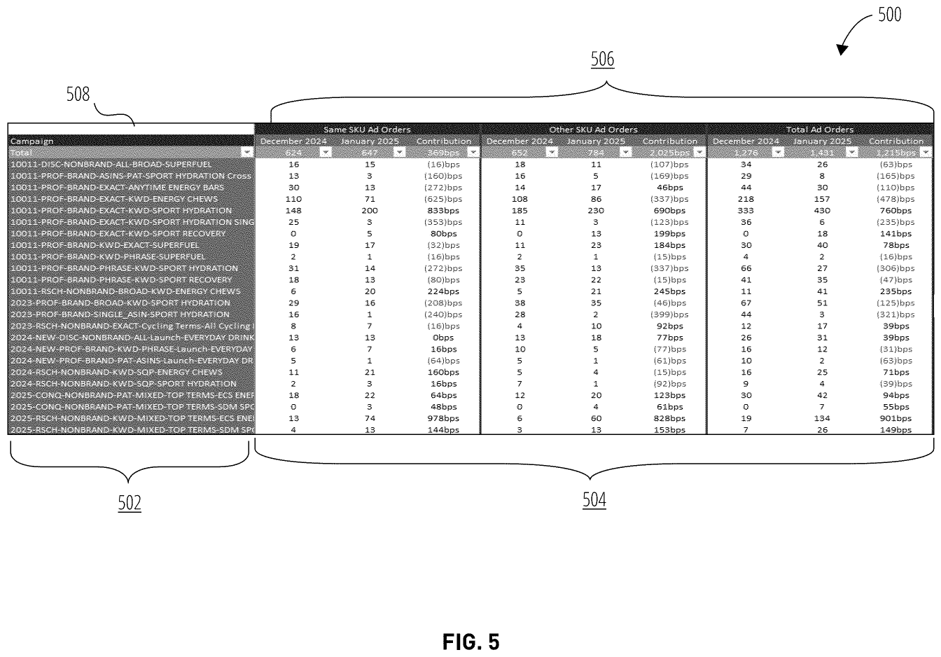

The Hierarchical Attribution Layer (shown in FIG. 2) further processes the data through two main mechanisms:
1. Single-Metric Decomposition (Vertical Bridge): Business metrics are decomposed hierarchically to determine the specific contribution of each entity level (e.g., Region→Brand→SKU) to any observed changes in performance. This allows for a precise understanding of how each level of the business contributes to overall performance shifts. An example decomposition of business metrics is shown in FIG. 5.
2. Cross-Metric Attribution (Horizontal Bridge): This mechanism examines the interaction between multiple performance drivers, helping to determine their combined influence on a target metric. For example, the system can assess how changes in one metric, such as ACOS, are influenced by variations in other metrics like CPC, Conversion Rate, and AOV. An example attribution is shown in FIG. 4.

The output generated from this attribution process can be structured and presented through comprehensive reporting and dashboards. The Vertical Bridge provides a tree-based breakdown, demonstrating how a single metric, such as revenue growth, is attributed to various business dimensions like SKU, brand, and region. On the other hand, the Horizontal Bridge displays multi-metric dashboards, offering insights into how changes in one metric, such as traffic, directly influence another, like revenue.

By structuring both the input data and the output visualizations in this way, HCAM system 108 enables businesses to trace every metric shift to its underlying drivers. This structured and deterministic approach provides clear and actionable attribution at all levels of analysis.

In an example embodiment, HCAM system 108 may receive reports 110 related to a business enterprise and data from external sources 112. Based on the reports 110, HCAM system 108 can determine a first set of values for business metrics for a first period and a second set of values for the business metrics for a second period. The first period and the second period can be as one as a day, a week, a month, or a year. HCAM system 108 can identify changes in the business metrics based on a comparison of the first set of values and the second set of values. Using a hierarchical decomposition model (Vertical Bridge) and a cross-metric attribution model (Horizontal Bridge), HCAM system 108 can determine a set of factors contributing to the changes in the business metrics. Based on predictable rules using deterministic functional relationships, rather than probabilistic statistical inference, HCAM system 108 can determine a set of impacts 116 of the set of factors. HCAM system 108 can visualize the set of impacts 116 for a user and generate messages 114 concerning the changes in the business metric, set of factors and set of impacts contributed to the changes. Messages 114 can be partially based on data obtained from external sources 112, for example online websites and search engines. The data from external sources 112 may include a media event associated with a third party, a whether event, and a shift in search-related traffic associated with at least one search platform, and other information that may affect the changes in business metric between the first period and the second period or within the second period.

FIG. 2 is a block diagram showing HCAM system 108, according to some example embodiments. FIG. 2 illustrates the architecture of HCAM system 108, which is structured around the Bridge Cube framework and includes the following key modules designed to enable deterministic, real-time performance attribution.

Metric Decomposition Engine 202 is responsible for extracting business metric shifts and applying deterministic decomposition rather than relying on statistical inference. This module forms the foundation of the Vertical Bridge, enabling a structured and hierarchical breakdown of performance metrics.

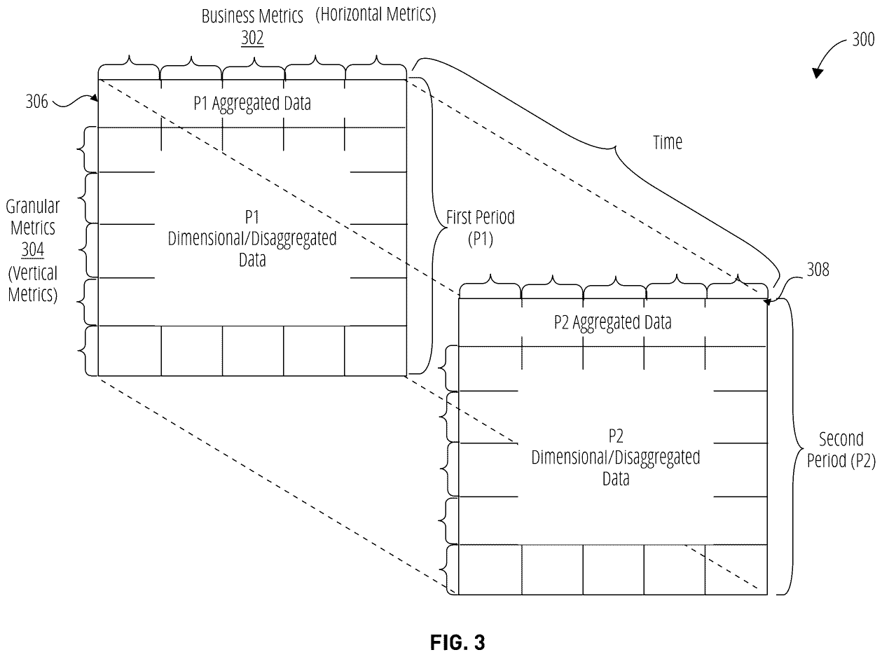

Hierarchical Attribution Layer 204 comprises two primary modules:
Single-Metric Decomposition Module 206 (Vertical Bridge) processes absolute and calculated metric shifts within a tree-based structure, as illustrated in FIG. 3.
Cross-Metric Attribution Module 208 (Horizontal Bridge) analyzes interactions between multiple performance drivers, such as traffic, conversion rate, and average Selling Price (ASP), ensuring real-time causal quantification, as visualized in FIG. 4.

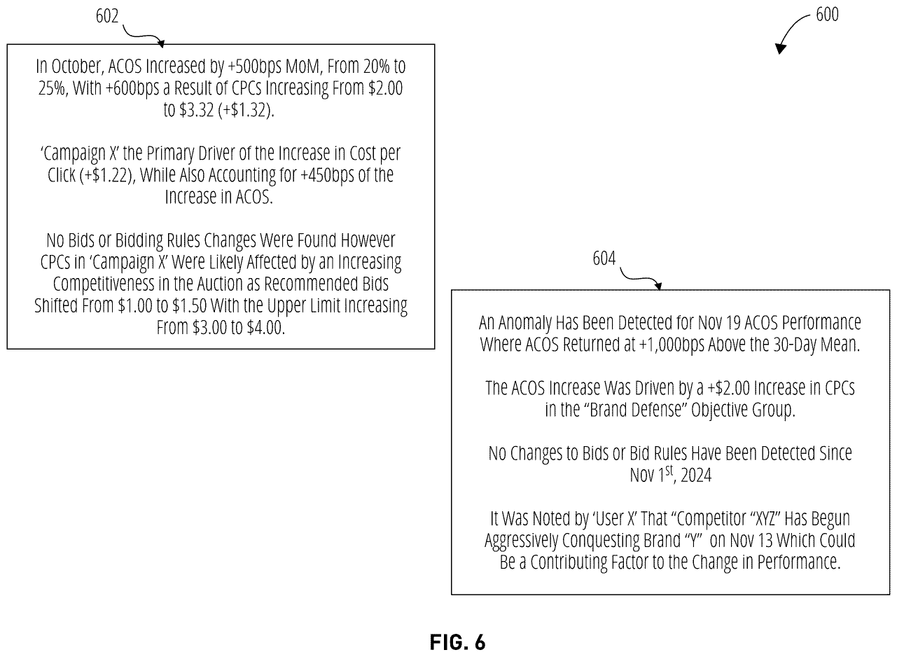

Causal Impact Quantification Module 210 calculates both direct and indirect effects using deterministic functional mappings rather than inference-based models. FIG. 6 illustrates how causal weightings are assigned to each input factor, enabling precise attribution of performance changes.

Real-Time Data Processing and API integration module 212 facilitates the embedding of HCAM insights into Business Intelligence (BI) dashboards, reports, and API-enabled enterprise analytics stacks. FIG. 5 highlights how attribution insights are displayed for decision-makers, ensuring accessibility and integration within enterprise workflows.

By integrating these components into a structured attribution framework, HCAM system 108 provides deterministic, real-time performance insights, eliminating ambiguity and reliance on correlation-based estimations present in conventional BI and Machine Learning (ML) models.

Referring back to FIG. 2, metric decomposition engine 202 within the HCAM framework is responsible for processing input-output relationships for business metrics, often referred to as key performance indicators (KPIs) or calculated metrics. These metrics are categorized into two primary types: absolute metrics and calculated metrics. Absolute metrics are raw, directly measured data points that do not require computation, such as total revenue, number of orders, or website visitors. Absolute metrics may include a number of times a product was displayed on a web page to users, a number of clicks on the web page, a number of sales of the product, a cost of an order of the product, and advertisement spend. In contrast, calculated metrics are derived from absolute metrics through mathematical operations like ratios, percentages, or averages. Examples of calculated metrics include Conversion Rate (ConvR), which is derived by dividing Orders by Clicks, and Advertising Cost of Sales (ACOS), which is determined by dividing Ad Spend by Revenue.

Within HCAM system 108, these metrics are structured using two complementary attribution methodologies: the Vertical Bridge (single-metric decomposition) and the Horizontal Bridge (cross-metric attribution). The Vertical Bridge, as illustrated in FIG. 5, hierarchically decomposes both absolute and calculated metrics across various business dimensions. This allows for the attribution of performance changes at multiple levels, such as Region→Brand→SKU. For instance, if total revenue increases by 15%, the Vertical Bridge can quantify the specific contribution of each product category and SKU to this growth, providing a granular breakdown of performance shifts.

The Horizontal Bridge, shown in FIG. 4, focuses on quantifying how multiple business inputs interact to influence a target metric. This method is particularly useful for calculated metrics that have interdependencies, such as ACOS, which depends on other factors like Cost per Click (CPC), Conversion Rate (ConvR), and Average Order Value (AOV). Traditional business intelligence tools often struggle to attribute changes in calculated metrics because they are composite in nature. However, HCAM system 108 overcomes this challenge by dynamically restructuring performance formulas to isolate the precise contribution of each input variable. For example, instead of treating ACOS as a simple ratio of Ad Spend to Revenue, HCAM system 108 decomposes it into its core components: ACOS =(CPC/ConvR) / AOV. This allows for more accurate attribution by quantifying how changes in CPC, ConvR, and AOV directly impact ACOS performance.

By utilizing deterministic decomposition through the Vertical Bridge for absolute metrics and the Horizontal Bridge for calculated metrics, HCAM system 108 ensures that every performance change is attributed to its root cause. Metric decomposition engine 202, as illustrated in FIG. 2, orchestrates this structured analysis, applying explicit mathematical relationships rather than relying on statistical inference. This approach provides real-time, explainable attribution insights, eliminating the uncertainty typically associated with traditional machine learning-based feature importance rankings or heuristic business intelligence models.

Metric decomposition engine 202 utilizes deterministic equations to accurately quantify the impact of input metrics on changes in business performance. Thus, in contrast to models that rely on statistical inference or correlation-based estimations, the HCAM system 108 defines the mathematical relationships between input and output metrics explicitly, ensuring a structured and transparent attribution process.

The HCAM system 108 employs explicit functional mappings to break down both absolute and calculated metrics, with the Vertical Bridge (FIG. 5) providing a hierarchical decomposition. This method identifies and isolates the contributions of various organizational levels, allowing for precise attribution of performance changes. In addition, the Horizontal Bridge (FIG. 4) assesses the combined influence of multiple interacting metrics on a target outcome, offering a detailed view of how different business factors work together to affect performance.

By relying on deterministic functional relationships, HCAM system 108 ensures that every performance shift is fully explained through structured, mathematical decomposition. This approach eliminates the need for probabilistic inference, providing clear and reliable attribution without relying on inferred probabilities.

Single-metric decomposition module 206 generates a tree-based causal structure that hierarchically maps the factors contributing to changes in a business metric. In this model, the parent node represents the primary business metric, such as revenue, while the child nodes correspond to the contributing dimensions, including factors like product line, brand, or region. Each child node can be further subdivided into more granular sub-level components, such as Product Identification Numbers (PINs) or Stock Keeping Units (SKUs), providing precise attribution of shifts in the metric.

As depicted in FIG. 5, this hierarchical decomposition allows businesses to accurately quantify the specific contributions of each dimension to an overall performance change. For example, if total revenue increases by 15%, HCAM system 108 systematically decomposes this growth across various product categories, SKUs, and regional sales channels, identifying which sub-components played the most significant role in the increase. This structured attribution approach ensures that businesses receive a clear, deterministic explanation of how changes in business metrics occur over time.

Referring back to FIG. 2, Single-metric decomposition module 206 can determine each component's contribution (positive or negative) to overall metric change and enables a multi-tiered performance attribution framework that explains metric shifts at every level. Single-metric decomposition module 206 can calculate percentage-based impacts for absolute metrics, and absolute and percentage-based impacts for calculated metrics, for full attribution clarity.

Cross-metric attribution module 208 is configured to quantify how multiple business metrics interact to impact an outcome. In one embodiment, cross-metric attribution module 208 constructs a second tree-based causal structure, wherein each parent node represents a business metric (for example, revenue) and each corresponding child node represents a contributing factor (for example, average selling price (ASP), conversion rate, and traffic). Traffic may refer to the volume of visitors or sessions on a website or a sales platform. Conversion rate may refer to the percentage of online visitors who complete a desired action—such as making a purchase, signing up for a service, or filling out a form—relative to the total number of visitors. Furthermore, each child node can be further subdivided into secondary factors (for example, orders and clicks for conversion rate).

Cross-metric attribution module 208 can determine how changes in contributing factors and secondary factors collectively contribute to changes in business metrics. For example, cross-metric attribution module 208 can determine how changes in traffic, conversion rate, and ASP contribute to changes in revenue. Cross-metric attribution module 208 can calculate both absolute and percentage-based changes for full attribution clarity.

Causal impact quantification module 210 can assign quantitative weights to each factor by calculating net impact on performance. While calculating the impacts, causal impact quantification module 210 uses deterministic functional equations to compute each input's contribution of each factor, without using probabilistic machine learning techniques. This allows differentiation between direct and indirect effects, ensuring businesses understand both primary drivers and secondary influences.

Real-time data processing and API integration module 212 can provide BI dashboards showing the changes in the business metrics, the set of factors affecting the changes and the set of impacts showing the contribution of the set of factors to the changes in the business metrics. Real-time data processing and API integration module 212 can be implemented as a standalone system or an API-based service for enterprise data teams. Real-time data processing and API integration module 212 ca process performance date in real-time or batch mode.

HCAM system 108 can be used for a variety of practical applications across multiple business sectors. For instance, in the e-commerce and retail domain, HCAM system 108 can perform detailed attribution analysis of key performance indicators such as revenue, profit, and conversion rate by decomposing these metrics into their constituent input variables. In the field of advertising and marketing, HCAM system 108 may facilitate precise, causality-based attribution of critical indicators such as ACOS, Return on Advertising Spend (ROAS), and overall advertising spend, thereby ensuring that marketing investments are directly linked to measurable outcomes. Additionally, within finance and operations, HCAM system 108 is capable of identifying cost drivers, monitoring margin fluctuations, and enhancing forecasting accuracy through a systematic mapping of input factors to financial outputs.

In various embodiments, HCAM system 108 processes both internal business performance data and external contextual data, ensuring a structured approach to attribution while preserving the integrity of deterministic modeling.

The primary function of the HCAM system 108 is deterministic causal attribution, which explicitly maps performance shifts to their corresponding input drivers. Business performance reports containing historical metrics—such as Ad Spend, Revenue, Clicks, Conversion Rate, and Advertising Cost of Sales (ACOS)—are structured hierarchically for analysis. As illustrated in FIG. 5, internal business data is decomposed using the Vertical Bridge analysis, mapping period-over-period changes to underlying business dimensions, such as Region →Brand →SKU. This structured approach enables precise identification of the factors driving performance fluctuations.

While the HCAM system 108 is fundamentally designed for deterministic attribution, external data signals may provide additional context for performance fluctuations. As shown in FIG. 6, external factors—such as competitor activity, media exposure, and search trend fluctuations—can be incorporated into ACOS anomaly detection, layering contextual insights onto the deterministic attribution framework.

In example embodiments, deterministic attribution can be combined with external data as follows. For example, ACOS increased by 10% despite stable Cost per Click (CPC) and Conversion Rate. The system deterministically identifies which campaigns, brands, and SKUs contributed to the observed change in ACOS as shown in FIG. 5. Based on supplemental external data, HCAM system 108 detects that a new competitor has launched aggressive Sponsored Ads in the same category, increasing auction competitiveness and influencing ACOS fluctuations and report it to a user (as shown in FIG. 6).

To ensure the accuracy of causal attribution, the HCAM system 108 maintains a clear distinction between internal business data and external contextual data:
Internal Data (Deterministic Attribution): Root cause analysis is conducted based strictly on business performance data, explicitly mapping metric shifts to underlying input variables.
External Data (Market Context Layering): External signals provide supplemental insights that explain performance fluctuations beyond direct business inputs, without modifying the mathematical attribution models.

By structuring a clear separation between deterministic internal attribution and external qualitative influences, the HCAM system 108 enables businesses to rely on precise, real-time attribution while integrating external insights for deeper strategic decision-making.

FIG. 3 is a schematic diagram 300 showing data used by HCAM system 108, according to some example embodiments. Table 306 depicts data collected from reports of a business enterprise during the first period (P1). Data may include dimensional/disaggregated data and aggregated data. Table 308 depicts data collected from reports of the business enterprise during the second period (P1).

Dimensional or disaggregated data refers to granular metrics 304 that serve as the foundational elements from which aggregated data are derived. These granular metrics 304 represent the most detailed level of data available, enabling complete drill-down analysis. For example, granular metrics may capture advertising spend at various levels of aggregation, with the most detailed level recording the expenditure on a specific search term. Higher-level aggregations may then be constructed, such as grouping by keyword by match type, ad group, and campaign.

Dimensional data may also include intermediate aggregations of the underlying data that add context and segmentation to performance metrics. These dimensions categorize data into meaningful groups to enhance analysis. Primary dimensions can be standard aggregations inherent to the dataset, such as campaign type (e.g., sponsored products, sponsored brands). Secondary dimensions can be user-defined custom aggregations that reflect specific performance conceptualizations, such as an item group, which groups products by shared characteristics (e.g., by brand, price tier, or product category). This approach to dimensionality allows for the analysis of performance across multiple layers and levels, offering a flexible framework for data segmentation and interpretation beyond fully aggregated data.

Aggregated data summarizes the granular metrics to obtain business metrics 302. These business metrics provide a top-level view of performance and include key indicators such as: total spend, ad sales, ACOS, impressions, clicks, click-through rate (CTR), cost per acquisition (CPA), average order value (AOV), cost per click (CPC), ad conversion rate, and so forth.

Cross-metric attribution module 208 (as illustrated in FIG. 2) correlates business metrics 302 with their underlying input metrics to elucidate the reasons behind observed output changes. This mapping is based on the mathematical relationships among the metrics and the influence that adjustments in input variables exert on outcomes. For example, consider Advertising Cost of Sales (ACOS). Traditionally defined as Advertising Spend divided by Advertising Sales, ACOS is reformulated in this system to better align inputs with outputs as follows: ACOS=(Cost per Click÷Ad Conversion Rate)÷Average Order Value. This reformulation clearly demonstrates how variations in key input metrics drive changes in ACOS, thereby enabling precise attribution of performance shifts to specific, actionable inputs.

Single-metric decomposition module 206 (shown in FIG. 2) identifies the origins of performance changes within a given metric by systematically drilling down through all levels of data—from aggregated dimensions to fully disaggregated data points. Two calculations are implemented:

Mix: Applicable to absolute business metrics (e.g., spend, sales), single-metric decomposition module 206 quantifies the contribution of disaggregated or dimensional data to the percentage change observed in an absolute business metric. For example, if spend increases by 50% period-over-period, single-metric decomposition module 206 determines the impact of each dimension (such as campaigns or item groups) on that 50% increase.

Mix-Rate: Applicable to calculated metrics (e.g., ConvR, CPC, ACOS), single-metric decomposition module 206 elucidates both the net change drivers (for example, an increase of 5 percentage points in ACOS) and the percentage change drivers (for example, a 50% increase in ACOS). This calculation accounts for:
Mix Change: The effect of shifts in underlying dimensions (such as variations in the distribution of spend across campaigns) on the calculated metric.
Rate Change: The impact of changes in the metric itself (for example, ACOS) on the overall performance shift.

This hierarchical approach enables precise attribution of performance variations to their underlying drivers, thereby facilitating more informed decision-making.

By combining analysis performed by cross-metric attribution module 208 and single-metric decomposition module 206, HCAM system 108 enables users to: identify the primary drivers of performance changes across input metrics (horizontal analysis) and attribute changes within individual metrics to specific dimensions or disaggregated data points (vertical analysis).

FIG. 4 is a schematic diagram 400 showing example dashboard screens, according to an example embodiment. In FIG. 4, dashboard screen 402 depicts results of analysis performed by cross-metric attribution module 208 (horizontal analysis) for changes in ACOS from period 1 to period 2. Dashboard screen 404 depicts contribution to ACOS change from CPC, AOV, and ConvR.

FIG. 5 depicts an example dashboard screen 500, according to an example embodiment. Dashboard screen 500 includes a table 508. Rows of table 306 correspond to a set of factors 502, such as individual advertisement campaigns. Columns of table 508 correspond to business metrics 506, such as spend, total advertisement sales, and ACOS. The values of cells of table 508 correspond to set of impacts 504 of the individual advertisement campaigns to the changes in business metrics 506. The impact can be determined by single-metric decomposition module 206 as described in FIG. 2 and FIG. 3.

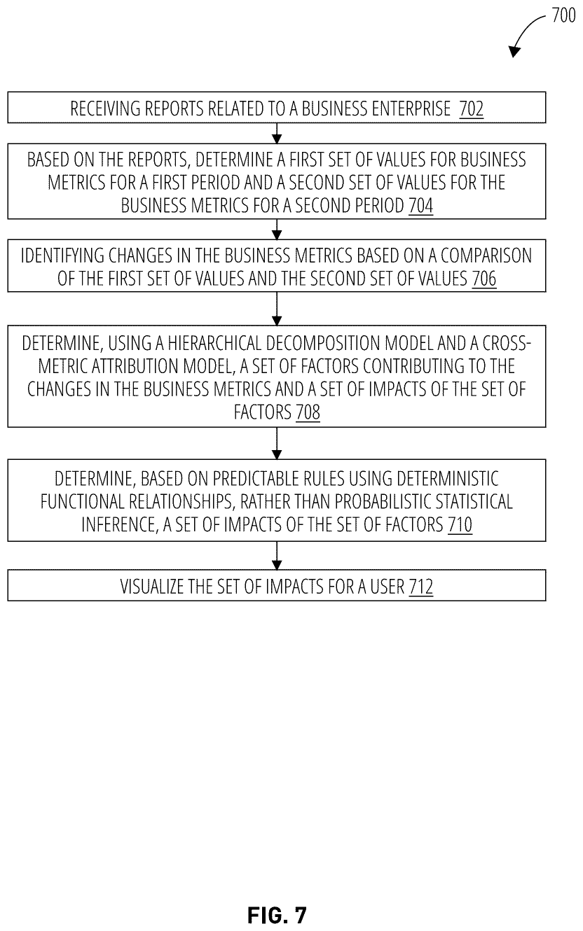

FIG. 6 is a schematic diagram 600 depicting example messages generated by HCAM system 108, according to some example embodiments. In some embodiments, the HCAM system 108 analyzes the impacts of various factors on a business metric and identifies a primary factor that results in the largest impact among the set of impacts. The HCAM system 108 then generates a message regarding the primary factor and the corresponding change in the business metric, and displays the message to the user. In FIG. 7, message 602 is an example of a message concerning a primary factor (primary driver) accounting for the increase in ACOS.

In some embodiments, real-time data processing and API integration module 212 can analyze the impacts of various factors on a business metric in real time and report any anomalies to the user. Additionally, real-time data processing and API integration module 212 analyzes traffic on a sales platform to identify events that may have caused the anomaly and incorporates this information into the message. In FIG. 7, message 604 is an example message that includes an alert regarding an anomaly detected in ACOS.

In some embodiments, HCAM system 108 may analyze changes in dimensional or disaggregated data (changelog) and link the changes to business metrics. For instance, an analysis revealed a five-percentage-point increase in ACOS, driven primarily by an increase in CPC, with Campaign X identified as the principal driver. To determine the underlying cause, HCAM system 108 examines changelog data points that could impact CPC, including adjustments to bids, changes in recommended bids and bid distributions (which serve as proxies for auction competitiveness and quality scores), and updates to bidding rules, bid modifiers, and bid strategy. Upon reviewing the changelog for Campaign X, HCAM system 108 determines that no modifications were made to bids, bidding rules, bid modifiers, or bid strategy between the analyzed periods, and that recommended bids and bid distributions shifted upward, indicating a more competitive and costly auction environment.

In some embodiments, HCAM system 108 may enable user to make annotations to specific dates in changelog. For example, the user may indicate that a specific date was associated with a specific event on the sales platform. Annotations may be associated with specific dimensions, such as campaigns or product groups, or alternatively applied holistically across the dataset. Annotations may be connected to impacted performance metrics, with the option for users to manually identify these metrics or to select them from a predefined catalog incorporated into the system's architecture. Annotations may be designated with a specific date or date range corresponding to an event, scenario, or annotation, thereby facilitating the association of performance metrics with the annotated item. HCAM system 108 can generate messages based partially on the annotations from the users.

In one embodiment, a user annotates that a new competitor has begun advertising aggressively on the brand's detail page on a specific date. This event introduces heightened auction competitiveness, which is likely to result in increased CPC, particularly for branded keywords. HCAM system 108 can incorporate this context to generate the following example message: “ACOS increased by 5 percentage points period-over-period, driven primarily by an increase in CPC, with Campaign X identified as the principal driver. Although no changes to bids or bidding rules were observed, the CPCs in Campaign X were likely affected by increased auction competitiveness, as evidenced by recommended bids rising from $1.00 to $1.50 and the upper bid limit increasing from $3.00 to $4.00. Additionally, Competitor XYZ was noted to have begun actively targeting the brand's detail page on [X date]. This activity was associated with a 40% increase in branded keyword activity within Campaign X, beginning three days before the annotated event date.”

In some embodiments, HCAM system 108 can incorporate external data from external sources 112 to indicate potential cause of the external data to changes and anomalies in business metrics. Example external data may include:

Media Exposure: An entity's products may experience increased interest and demand when featured in various media outlets, such as blogs, television programs, or clinical studies.

Affiliate Events: Investments in field events, social media campaigns, or external paid media—which are not directly attributable through standard digital attribution mechanisms—can also influence performance metrics.

Weather Events: Natural disasters, such as hurricanes, may drive heightened interest in specific products (for example, generators), thereby affecting key performance metrics like sales and traffic.

Search Trends: Data from public search trend analysis platforms or marketplace search query performance can reveal shifts in search term interest; a surge in interest for particular search terms may correlate with improved product performance.

An example message that incorporates the external data can be as follows: “Brand X saw a 50% increase in Sales month-over-month, driven by Item Group X. Products in this group were featured on [TV Show] on [X date], coinciding with the timing of the demand spike. During the same period, Spend increased by 30% and Advertising Sales by 40%. As a result, Weeks of Cover for these products fell to 2 weeks, below the targeted threshold. Immediate restocking is recommended to avoid an out-of-stock scenario.”

FIG. 7 is a flow diagram showing a method 700 for HCAM, according to some example embodiments. Method 700 may be performed by processing logic that comprises hardware (e.g., decision-making logic, dedicated logic, programmable logic, ASIC, and microcode), software (such as software run on a general-purpose computer system or a dedicated machine), or a combination of both. Method 700 may have additional operations not shown herein, but which can be evident to those skilled in the art from the present disclosure. Method 700 may also have fewer operations than outlined below and shown in FIG. 7.

In block 702, method 700 includes receiving reports related to a business enterprise. In block 704, method 700 includes determining, based on the reports, a first set of values for business metrics for a first period and a second set of values for the business metrics for a second period. The business metrics may include absolute business metrics and calculated business metrics. The length of the first period and corresponding length of the second period can be a day, a week, a month, a year, and the like. The business metrics may include a business metric associated with one or more of the following: a category of products, a brand associated with the products, and a price tier of the products.

In block 706, method 700 includes identifying changes in the business metrics based on a comparison of the first set of values and the second set of values. The business metrics may include input metrics and at least one performance metric calculated based on the input metrics. The input metrics may include one or more of the following: a number of times a product displayed on a web page displayed to users, a number of clicks on the web page, a number of sales of the product, cost of an order of the product, and an advertisement spend. The performance metric may include one or more of the following: an advertisement cost of sales, cost per click, an advertisement conversion rate, and an average order value.

In block 708, method 700 includes determining, using a hierarchical decomposition model (Vertical Bridge) and a cross-metric attribution model (Horizontal Bridge), a set of factors contributing to the changes in the business metrics. In block 710, method 700 includes determining, based on predictable rules using deterministic functional relationships, rather than probabilistic statistical inference, a set of impacts of the set of factors.

Factors in the set of factors can be arranged in a hierarchical tree including a vertical bridge decomposition layer and a horizontal bridge attribution layer. The vertical bridge decomposition layer may include at least one parent node corresponding to a primary business metric of the business metrics and a child node associated with the parent node. For example, the primary business metric may include revenue, profit, and so forth. The child node may correspond to a contributing dimension contributing to the primary business metric. The contributing dimension may include brand, region, SKU, and so forth. The vertical bridge decomposition layer may include at least one sub-level node associated with the child node. The sub-level node may correspond to an individual entity identifier associated with the contributing dimension. The individual entity identifier may include a product identifier, an SKU, campaign identifier, and so forth.

The horizontal bridge attribution layer may include a further parent node corresponding to a calculated business metric of the business metrics and a further child node associated with the further parent node. The calculated business metric may include ACOS, ROAS, and the like. The further child node may correspond to an input driver contributing to the calculated business metric. The input driver may include CPC, ConvR, AOV, and the like. Multiple input drivers may interact to influence the calculated business metric (a target metric).

The set of factors may include a factor associated with one or more of the following: an advertisement campaign, a brand associated with a product, a category of the product, and a geographical location. The set of factors may include an external factor associated with one or more of the following: a media event associated with a third party, a whether event, and a shift in search-related traffic associated with at least one search platform. The external factors can be retrieved through third-party APIs or external data sources. The external factors can be processed separately from internal business data to maintain structured deterministic attribution. The external factors can be used as qualitative contextual layers rather than direct mathematical attributions within HCAM's causal impact quantification framework.

In block 712, method 700 includes visualizing the set of impacts for a user. Visualization of the set of impacts can be carried out through interactive dashboards, reports, or automated messaging systems. The set of impacts can be visualized as a table. The rows of the table may correspond to factors of the set of factors. The factors may include individual factors and sub-factors contributing to the changes in the business metrics. Columns of the table may correspond to the business metrics at multiple levels of aggregation. The table can be dynamically adjusted to reflect real-time performance shifts in the business metrics based on updated data in the reports.

Method 700 may also include determining a primary factor of the set of factors. The primary factor may result in one of the following: a largest direct impact on a change in a business metric of the business metrics and a largest indirect impact on the change in the business metric. Method 700 may include generating a message concerning the primary factor and the change in the business metric corresponding to the primary factor and displaying the message to the user. The message can be contextually enriched using a retrieval-augmented generation (RAG) system that retrieves supporting structured attribution data from reports. Additionally, the message can be generated by a pretrained neural network, such as a large language model (LLM), to enhance interpretability.

Method 700 may include applying a decomposition for an absolute metric of the business metrics to determine first components and the second components. The first components may correspond to contributions of shifts in underlying data dimensions to a total change of the absolute metric. Underlying data dimensions may include, for example, campaign, region, SKU, and so forth. The second component isolates the total change of the absolute metric from the first components. Method 700 may include applying an attribution for a calculated business metric of the business metrics to quantify a contribution of an input driver to the calculated business metric. For example, input drivers may include CPC, ConvR, AOV for ACOS calculation. Method 700 may include determining a first shift in the calculated business metric and a second shift in the calculated business metric. The first shift can be caused by budget allocation changes and the second shift is caused by rate driven changes (for example CPC fluctuations).

Method 700 may include providing an application programming interface (API). The API can be configured to receive an attribution query concerning the set of impacts and return attribution data based on the set of impacts in real time. The API can continuously receive the reports as a batch of first streaming data and continuously return second streaming data including the set of impacts based on the reports. The API can generate an alert message based on predetermined thresholds on the business metrics.

Method 700 may include generating a message concerning attribution data including impacts of the set of impacts to the changes to the business metrics and a summary concerning the changes in the business metrics. Method 700 may include displaying the message to the user. The attribution data can be generated using a retrieval-augmented generation (RAG) system. The summary can be generated by a large language model (LLM). The message can be presented in natural language and preserve the attribution data.

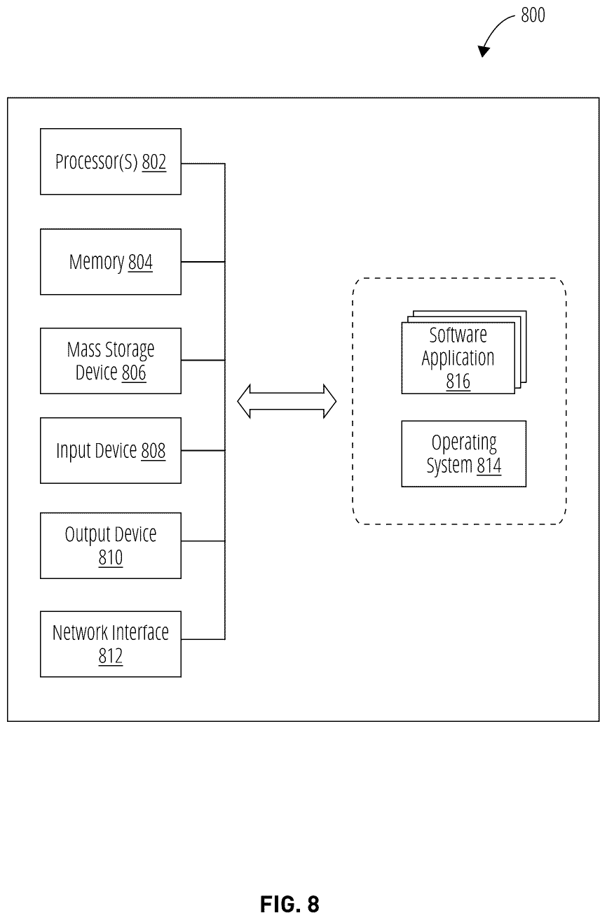

FIG. 8 is a high-level block diagram illustrating an example computer system 800, within which a set of instructions for causing the machine to perform any one or more of the methodologies discussed herein can be executed. The computer system 800 may include, refer to, or be an integral part of, one or more of a variety of types of devices, such as a general-purpose computer, a desktop computer, a laptop computer, a tablet computer, a netbook, a mobile phone, a smartphone, a personal digital computer, a smart television device, and a server, among others. In some embodiments, the computer system 800 is an example of a computing device 102 shown in FIG. 1. Notably, FIG. 8 illustrates just one example of the computer system 800 and, in some embodiments, the computer system 800 may have fewer elements/modules than shown in FIG. 8 or more elements/modules than shown in FIG. 8.

The computer system 800 may include one or more processor(s) 802, a memory 804, one or more mass storage devices 806, one or more input devices 808, one or more output devices 810, and a network interface 812. The processor(s) 802 are, in some examples, configured to implement functionality and/or process instructions for execution within the computer system 800. For example, the processor(s) 802 may process instructions stored in the memory 804 and/or instructions stored on the mass storage devices 806. Such instructions may include components of an operating system 814 or software applications 816. The computer system 800 may also include one or more additional components not shown in FIG. 8, such as a body, a power supply, a global positioning system (GPS) receiver, and so forth.

The memory 804, according to one example, is configured to store information within the computer system 800 during operation. The memory 804, in some example embodiments, may refer to a non-transitory computer-readable storage medium or a computer-readable storage device. In some examples, the memory 804 is a temporary memory, meaning that a primary purpose of the memory 804 may not be long-term storage. The memory 804 may also refer to a volatile memory, meaning that the memory 804 does not maintain stored contents when the memory 804 is not receiving power. Examples of volatile memories include random access memories (RAM), dynamic random access memories (DRAM), static random access memories (SRAM), and other forms of volatile memories known in the art. In some examples, the memory 804 is used to store program instructions for execution by the processor(s) 802. The memory 804, in one example, is used by software (e.g., the operating system 814 or the software applications 816). Generally, the software applications 816 refer to software Applications suitable for implementing at least some operations of the methods for hierarchical causal attribution modeling as described herein.

The mass storage devices 806 may include one or more transitory or non-transitory computer-readable storage media and/or computer-readable storage devices. In some embodiments, the mass storage devices 806 may be configured to store greater amounts of information than the memory 804. The mass storage devices 806 may further be configured for long-term storage of information. In some examples, the mass storage devices 806 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

The input devices 808, in some examples, may be configured to receive input from a user through tactile, audio, video, or biometric channels. Examples of the input devices 808 may include a keyboard, a keypad, a mouse, a trackball, a touchscreen, a touchpad, a microphone, one or more video cameras, image sensors, fingerprint sensors, or any other device capable of detecting an input from a user or other source, and relaying the input to the computer system 800, or components thereof.

The output devices 810, in some examples, may be configured to provide output to a user through visual or auditory channels. The output devices 810 may include a video graphics adapter card, a liquid crystal display (LCD) monitor, a light emitting diode (LED) monitor, an organic LED monitor, a sound card, a speaker, a lighting device, a LED, a projector, or any other device capable of generating output that may be intelligible to a user. The output devices 810 may also include a touchscreen, a presence-sensitive display, or other input/output capable displays known in the art.

The network interface 812 of the computer system 800, in some example embodiments, can be utilized to communicate with external devices via one or more data networks such as one or more wired, wireless, or optical networks including, for example, the Internet, intranet, LAN, WAN, cellular phone networks, Bluetooth radio, and an IEEE 902.11-based radio frequency network, Wi-Fi networks®, among others. The network interface 812 may be a network interface card, such as an Ethernet card, an optical transceiver, a radio frequency transceiver, or any other type of device that can send and receive information.

The operating system 814 may control one or more functionalities of the computer system 800 and/or components thereof. For example, the operating system 814 may interact with the software applications 816 and may facilitate one or more interactions between the software applications 816 and components of the computer system 800. As shown in FIG. 8, the operating system 814 may interact with or be otherwise coupled to the software applications 816 and components thereof. In some embodiments, the software applications 816 may be included in the operating system 814. In these and other examples, virtual modules, firmware, or software may be part of the software applications 816.

Thus, systems and methods for hierarchical causal attribution modeling have been described. Although embodiments have been described with reference to specific example embodiments, it will be evident that various modifications and changes can be made to these example embodiments without departing from the broader spirit and scope of the present Application. Accordingly, the specification and drawings are to be regarded in an illustrative rather than a restrictive sense.

1. A method comprising:
receiving, by a computing system comprising a processor and a memory, reports related to a business enterprise;
based on the reports:
determining:
a first set of values for business metrics for a first period; and
a second set of values for the business metrics for a second period;
identifying changes in the business metrics based on a comparison of the first set of values and the second set of values; and
determining:
using a hierarchical decomposition model and a cross-metric attribution model, each implemented by program instructions stored in the memory and executed by the processor, a set of factors contributing to the changes in the business metrics; and
based on predictable rules using deterministic functional relationships, rather than probabilistic statistical inference, a set of impacts of the set of factors, wherein:
the set of factors includes a first metric and a second metric;
the business metrics include a third metric calculated based on the first metric and the second metric using a deterministic functional relationship;
the set of impacts includes:
a first numerical contribution of a change of the first metric to a change of the third metric; and
a second numerical contribution of a change of the second metric to the change of the third metric, wherein the first numerical contribution and the second numerical contribution are calculated based on the deterministic functional relationship;
generating and displaying, via a graphical user interface, a visualization of the set of impacts, wherein the visualization includes a breakdown of contributions per categorical dimension;
generating a message concerning attribution data including impacts of the set of impacts to the changes to the business metrics and a summary concerning the changes in the business metrics; and
displaying the message to the user, wherein:
the attribution data are generated using a retrieval-augmented generation (RAG) system;
the summary is generated by a large language model (LLM); and
the message is presented in natural language and preserves the attribution data.

2. The method of claim 1, wherein the set of impacts is visualized as a table, wherein:
rows of the table correspond to factors of the set of factors, the factors including individual factors and sub-factors contributing to the changes in the business metrics;
columns of the table correspond to the business metrics at multiple levels of aggregation, the business metrics including absolute business metrics and calculated metrics; and
the table is dynamically adjusted to reflect real-time performance shifts in the business metrics based on updated data in the reports.

3. The method of claim 1, further comprising:
determining a primary factor of the set of factors, the primary factor resulting in one of the following: a largest direct impact on a change in a business metric of the business metrics and a largest indirect impact on the change in the business metric;
generating a message concerning the primary factor and the change in the business metric corresponding to the primary factor; and
displaying the message to the user.

4. The method of claim 1, wherein factors in the set of factors are arranged in a hierarchical tree, the hierarchical tree including a vertical bridge decomposition layer and a horizontal bridge attribution layer, wherein:
the vertical bridge decomposition layer includes:
at least one parent node corresponding to a primary business metric of the business metrics;
at least one child node associated with the at least one parent node, the at least one child node corresponding to a contributing dimension contributing to the primary business metric; and
at least one sub-level node associated with the at least one child node, the at least one sub-level node corresponding to an individual entity identifier associated with the contributing dimension; and
the horizontal bridge attribution layer includes:
a further parent node corresponding to a calculated business metric of the business metrics;
a further child node associated with the further parent node, the further child node corresponding to an input driver contributing to the calculated business metric.

5. The method of claim 1, further comprising:
applying a decomposition for an absolute business metric of the business metrics to determine:
first components corresponding to contributions of shifts in underlying data dimensions to a total change of the absolute business metric;
a second component isolating the total change of the absolute business metric from the first components; and
applying an attribution for a calculated business metric of the business metrics to:
quantify a contribution of an input driver to the calculated business metric; and
determine a first shift in the calculated business metric and a second shift in the calculated business metric, the first shift being caused by budget allocation changes, and the second shift being caused by a rate driven change.

6. The method of claim 1, further comprising providing an application programming interface configured to perform one or more of the following:
in real time: receiving an attribution query concerning the set of impacts and return attribution data based on the set of impacts;
continuously receiving the reports as batch of first streaming data and continuously return second streaming data including the set of impacts based on the reports; and
generating an alert message based on predetermined thresholds on the business metrics.

7. (canceled)

8. The method of claim 1, wherein the set of factors includes a factor associated with one or more of the following: an advertisement campaign, a brand associated with a product, a category of the product, and a geographical location.

9. The method of claim 1, wherein the set of factors includes an external factor associated with one or more of the following: a media event associated with a third party, a weather event, and a shift in search-related traffic associated with at least one search platform.

10. The method of claim 1, wherein the business metrics include a business metric associated with one or more of the following: a category of products, a brand associated with the products, and a price tier of the products.

11. The method of claim 1, wherein:
the business metrics includes input metrics and at least one performance metric calculated based on the input metrics; and
the input metrics include one or more of the following: a number of times a product displayed on a web page displayed to users, a number of clicks on the web page, a number of sales of the product, cost of an order of the product, and an advertisement spend.

12. The method of claim 11, wherein the at least one performance metric includes one or more of the following: an advertisement cost of sales, cost per click, an advertisement conversion rate, and an average order value.

13. A computing device comprising:
a processor; and
a memory storing instructions that, when executed by the processor, configure the computing device to:
receive reports related to a business enterprise;
based on the reports:
determine:
a first set of values for business metrics for a first period; and
a second set of values for the business metrics for a second period;
identify changes in the business metrics based on a comparison of the first set of values and the second set of values; and
determine:
using a hierarchical decomposition model and a cross-metric attribution model, each implemented by program instructions stored in the memory and executed by the processor, a set of factors contributing to the changes in the business metrics; and
based on predictable rules using deterministic functional relationships, rather than probabilistic statistical inference, a set of impacts of the set of factors, wherein:
the set of factors includes a first metric and a second metric;
the business metrics include a third metric calculated based on the first metric and the second metric using a deterministic functional relationship;
the set of impacts includes:
a first numerical contribution of a change of the first metric to a change of the third metric; and
a second numerical contribution of a change of the second metric to the change of the third metric, wherein the first numerical contribution and the second numerical contribution are calculated based on the deterministic functional relationship; and
generate and display, via a graphical user interface, a visualization of the set of impacts, wherein the visualization includes a breakdown of contributions per categorical dimension;
generate a message concerning attribution data including impacts of the set of impacts to the changes to the business metrics and a summary concerning the changes in the business metrics; and
display the message to the user, wherein:
the attribution data are generated using a retrieval-augmented generation (RAG) system;
the summary is generated by a large language model (LLM); and
the message is presented in natural language and preserves the attribution data.

14. The computing device of claim 13, wherein the set of impacts is visualized as a table, wherein:
rows of the table correspond to factors of the set of factors, the factors include individual factors and sub-factors contributing to the changes in the business metrics;
columns of the table correspond to the business metrics at multiple levels of aggregation, the business metrics include absolute business metrics and calculated metrics; and
the table is dynamically adjusted to reflect real-time performance shifts in the business metrics based on updated data in the reports.

15. The computing device of claim 13, wherein the instructions further configure the computing device to:
determine a primary factor of the set of factors, the primary factor resulting in one of the following: a largest direct impact on a change in a business metric of the business metrics and a largest indirect impact on the change in the business metric;
generate a message concerning the primary factor and the change in the business metric corresponding to the primary factor; and
display the message to the user.

16. The computing device of claim 13, wherein factors in the set of factors are arranged in a hierarchical tree, the hierarchical tree include a vertical bridge decomposition layer and a horizontal bridge attribution layer, wherein:
the vertical bridge decomposition layer includes:
at least one parent node corresponding to a primary business metric of the business metrics;
at least one child node associated with the at least one parent node, the at least one child node corresponding to a contributing dimension contributing to the primary business metric; and
at least one sub-level node associated with the at least one child node, the at least one sub-level node corresponding to an individual entity identifier associated with the contributing dimension; and
the horizontal bridge attribution layer includes:
a further parent node corresponding to a calculated business metric of the business metrics;
a further child node associated with the further parent node, the further child node corresponding to an input driver contribute to the calculated business metric.

17. The computing device of claim 13, wherein the instructions further configure the computing device to:
apply a decomposition for an absolute business metric of the business metrics to determine:
first components corresponding to contributions of shifts in underlying data dimensions to a total change of the absolute business metric;
a second component isolate the total change of the absolute business metric from the first components; and
apply an attribution for a calculated business metric of the business metrics to:
quantify a contribution of an input driver to the calculated business metric; and
determine a first shift in the calculated business metric and a second shift in the calculated business metric, the first shift being caused by budget allocation changes, and the second shift being caused by a rate driven change.

18. The computing device of claim 13, wherein the instructions further configure the computing device to provide an application programming interface configured to perform one or more of the following:
in real time: receive an attribution query concerning the set of impacts and return attribution data based on the set of impacts;
continuously receive the reports as batch of first streaming data and continuously return second streaming data including the set of impacts based on the reports; and
generate an alert message based on predetermined thresholds on the business metrics.

19. (canceled)

20. A non-transitory computer-readable storage medium, the computer-readable storage medium including instructions that, when executed by a computing device comprising a processor and memory, cause the computing device to:
receive reports related to a business enterprise;
based on the reports:
determine:
a first set of values for business metrics for a first period; and
a second set of values for the business metrics for a second period;
identify changes in the business metrics based on a comparison of the first set of values and the second set of values; and
determine:
using a hierarchical decomposition model and a cross-metric attribution model, each implemented by program instructions stored in the memory and executed by the processor, a set of factors contribute to the changes in the business metrics; and
based on predictable rules using deterministic functional relationships, rather than probabilistic statistical inference, a set of impacts of the set of factors, wherein:
the set of factors includes a first metric and a second metric;
the business metrics include a third metric calculated based on the first metric and the second metric using a deterministic functional relationship;
the set of impacts includes:
a first numerical contribution of a change of the first metric to a change of the third metric; and
a second numerical contribution of a change of the second metric to the change of the third metric, wherein the first numerical contribution and the second numerical contribution are calculated based on the deterministic functional relationship ; and
generate and displaying, via a graphical user interface, a visualization of the set of impacts, wherein the visualization includes a breakdown of contributions per categorical dimension;
generate a message concerning attribution data including impacts of the set of impacts to the changes to the business metrics and a summary concerning the changes in the business metrics; and
display the message to the user, wherein:
the attribution data are generated using a retrieval-augmented generation (RAG) system;
the summary is generated by a large language model (LLM); and
the message is presented in natural language and preserves the attribution data.
